(19) United States
(12) Patent Application Publication
(10) Pub. No.: US 2004/0207596 A1
(43) Pub. Date: Oct. 21, 2004

(54) Portable computer with a flat panel display

(76) Inventor: Chih-Chiang Yu, Taipei (TW)

Correspondence Address: BIRCH STEWART KOLASCH & BIRCH, PO BOX 747, FALLS CHURCH, VA, 22040-0747, US

(21) Appl. No.: 10/664,166

(22) Filed: Sep. 17, 2003

(30) Foreign Application Priority Data
Apr. 16, 2003 (TW) 92205965

(51) Int. Cl. G09G 5/00

(52) U.S. Cl. 345/156

(57) ABSTRACT

A portable computer with a flat panel display is provided. The portable computer includes a base and a cover. Users input data selectively by an input device or through a flat panel display. The base includes a first portion and a second portion. The second portion has a flat panel display with handwriting and touching input functions. Moreover, the cover is pivotally connected to the base for protecting the base and can rotate to the back of the base. The cover includes the input device for inputting data to a computer system of the base.

### CROSS REFERENCE TO RELATED APPLICATIONS

This Application claims priority to Taiwan Patent Application No. 092205965 entitled “Cover Applied to a Computer with a Display,” filed Apr. 16, 2003.

### FIELD OF THE INVENTION

The present invention relates to a cover design, and more particularly, to a cover design applied to a computer with a flat panel display.

### BACKGROUND OF THE INVENTION

Portable electronic devices have become more and more popular nowadays with the development of technology. The market of, for example, the GSM/CDMA mobile phones, notebook computers, and other products, will grow even more rapidly in the forthcoming years.

However, owing to the trend of smaller size of portable electronic devices, designers adopt handwriting function and external keyboards in the input devices of portable electronic devices. FIG. 1 shows a schematic diagram of a personal digital assistant (PDA) of the prior art. The display 108 of the PDA 100 can be used to input data by handwriting. The PDA 100 doesn't have a built-in keyboard, and will need an external keyboard in some occasions. FIG. 2 shows a schematic diagram of the flat computer of the prior art. The flat computer 200 includes an input device 210 disposed on the base 202 which has a computer system within. The cover 204 includes a display 208 but does not have a keyboard.

To sum up, the covers of portable computers of prior arts don't have keyboards. If users of portable computers need to input data, they have to plug in external keyboards additionally. It causes inconvenience and wastes users' time. Moreover, without the protective covers, the displays are easily to be damaged.

### SUMMARY OF THE INVENTION

The present invention provides a cover design of a computer with a flat panel display. The cover design includes a cover and a base. The cover includes an input device so that users don't have to plug in another external keyboard to input data. Users can choose from the flat panel display and the keyboard to input data. Moreover, the flat panel display is not fixed at the angle of 90 degrees against the base, but is adjustable.

The present invention combines a computer system in a flat panel display and axially connects the flat panel display to a cover. The cover is light; so it doesn't do damage to the flat panel display but can protect it.

For the mentioned purposes, the present invention provides a cover design for a computer with a flat panel display, and the cover design includes a cover and a base. The base includes a first portion and a second portion, and the cover is pivotally connected to the base for protecting the base and can rotate to the back of the base. The first portion includes a computer system, and the second portion includes a flat panel display with a handwriting and touching input function. The cover has an input device to input data to the computer system of the base and protects the base.

In one of the preferred embodiment of the present invention, when the cover is in a first position, the cover covers the first portion. When the cover is in a second position, the cover covers the second portion to protect the flat panel display.

In one of the preferred embodiment of the present invention, the cover design includes a bracket connecting to the base. When the cover is placed on a plane, the bracket supports the base at an adjustable angle against the plane.

In one of the preferred embodiment of the present invention, the cover is removably connected to the base.

In one of the preferred embodiment of the present invention, the flat panel display has a handwriting input function.

In one of the preferred embodiment of the present invention, the input device includes a flat keyboard or a conductive-rubber keyboard which provides the flat panel display with better protection.

To conclude, the present invention provides a cover design for a computer with a flat panel display, and users can input data without plugging in an external keyboard. Moreover, the input device can be designed as big as the base and make it convenient for users to input data while they are moving.

### BRIEF DESCRIPTION OF THE DRAWINGS

FIG. 1 shows a schematic diagram of a personal digital assistant (PDA) of the prior art.

FIG. 2 shows a schematic diagram of a flat computer of the prior art.

FIG. 3 shows a schematic diagram of one preferred embodiment of the present invention applied to a computer with a flat panel display.

FIG. 4 shows a profile of another preferred embodiment of the present invention applied to a computer with a flat panel display.

FIG. 5 shows a schematic diagram of the preferred embodiment in FIG. 4 with the cover in the first position.

FIG. 6 shows a profile of the preferred embodiment in FIG. 5.

FIG. 7 shows a schematic diagram of the preferred embodiment of the present invention with the cover in the second position.

FIG. 8 shows a profile of the preferred embodiment in FIG. 7.

FIG. 9 shows a schematic diagram of the cover separated from the base in another preferred embodiment of the present invention.

### DETAILED DESCRIPTION OF THE INVENTION

FIG. 3 shows a schematic diagram of one preferred embodiment of the present invention applied to a computer with a flat panel display. The portable computer 300 with an input device can be a notebook computer or a tablet PC. The portable computer 300 with an input device is placed on a plane 314, and includes a base 302, a cover 304, a connection element 306, a flat panel display 308, an input device 310 and a bracket 312. There is a computer system in the base (not illustrated). The cover 304 is pivotally connected to the base 302 via the connection element 306, and the bracket is pivotally connected to the base 302. The computer system is disposed in the first portion 318 and the flat panel display 308 is disposed in the second portion 328 of the base 302. The flat panel display 308 in the second portion 328 has a handwriting function.

When the cover 304 is placed on the plane 314 providing an input function, the base 302 supported by the bracket 312 is at an angle against the plane 314. The angle is not restricted to 90 degrees.

As shown in FIG. 3, the cover 304 includes an input device 310 to input data to the computer system in the base 302. The input device 310 can be a keyboard made of special material to protect the flat panel display 308, for example, a conductive-rubber keyboard. In addition, the area of the input device 310 can be nearly the area of the cover 304, so the area of the input device 310 is larger than that of a conventional one. The cover 304 can axially rotate to the back of the base 302 around the connection element 306.

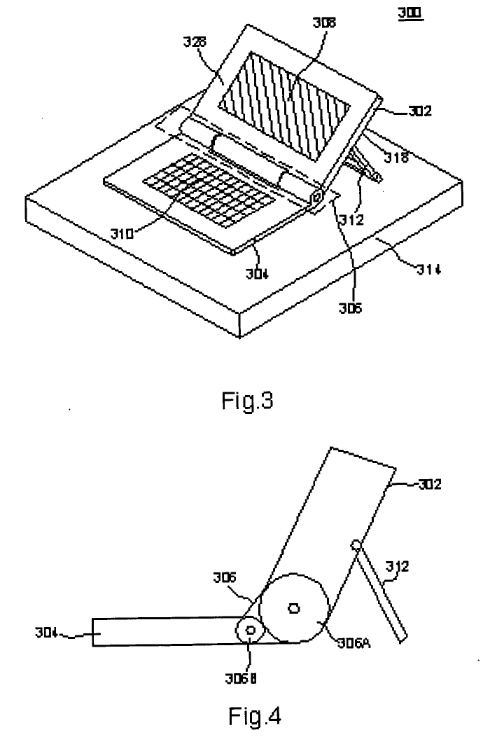

FIG. 4 shows a profile of another preferred embodiment of the present invention applied to a computer with a flat panel display. As shown in FIG. 4, the connection element 306 can be a bi-axis structure including a first axis 306A and a second axis 306B to connect the base 302 and the cover 304 respectively and acting as the axis of the rotation of the base 302 and the cover 304.

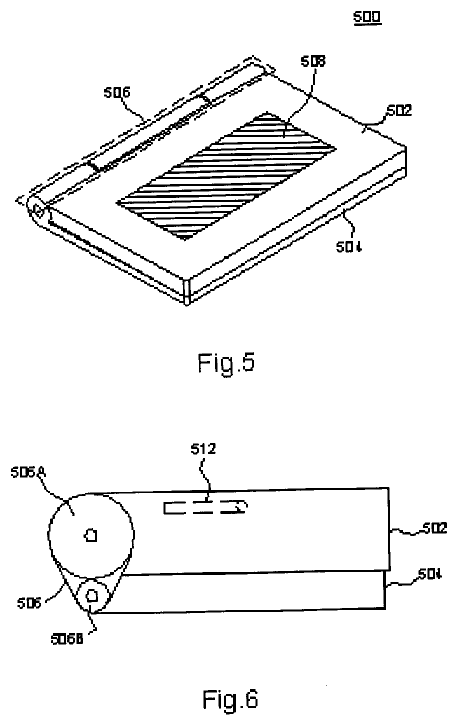

FIG. 5 shows a schematic diagram of the preferred embodiment in FIG. 4 with the cover in the first position. When the cover 304 rotates to a first position and covers a part of the base 302, users still can input data through the flat panel display 508 in the base 502 by handwriting. FIG. 5 shows a computer 500 of the preferred embodiment including a base 502, a cover 504, a connection element 506 and a flat panel display 508.

FIG. 6 shows a profile of the preferred embodiment of the present invention with the cover in the first position. The connection element 506 can be a bi-axis structure including a first axis 506A and a second axis 506B to connect the base 502 and the cover 504 respectively and acting as the axis of the rotation of the base 502 and the cover 504.

When the cover 504 rotates to a second position and covers a second portion 528 (not illustrated) of the base 502, the cover 504 protects the flat panel display 508. The cover 504 is light and will not do damage to the flat panel display 508. FIG. 7 shows a schematic diagram of the cover in the second position in the preferred embodiment of the present invention. As shown in FIG. 7, a computer 500 includes a base 502, a cover 504, a connection element 506, a flat panel display 508 and a bracket 512.

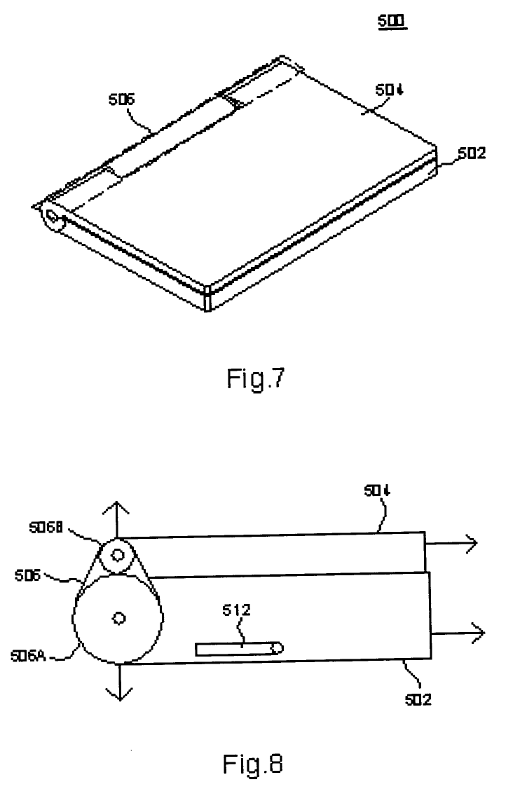

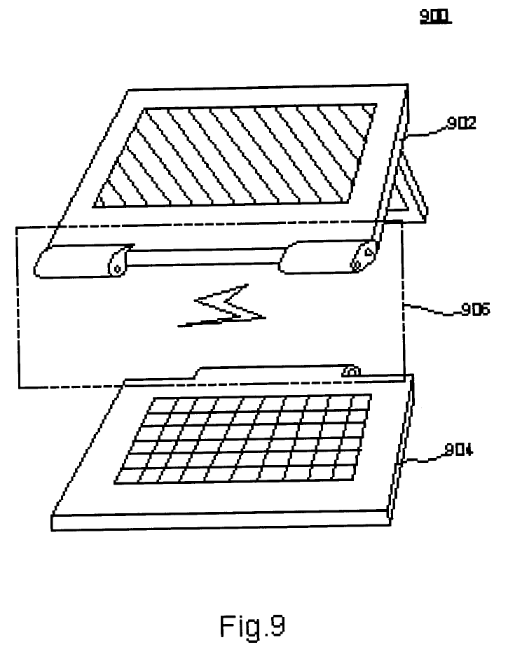

FIG. 8 shows a profile of the preferred embodiment of the present invention with the cover in the second position. As shown in FIG. 8, the connection element 506 can be a bi-axis structure including a first axis 506A and a second axis 506B to connect the base 502 and the cover 504 respectively. When the cover 504 rotates 180 degrees around the first axis 506A and 180 degrees around the second axis 506B from the first position to the second position, it covers and protects the flat panel display 508.

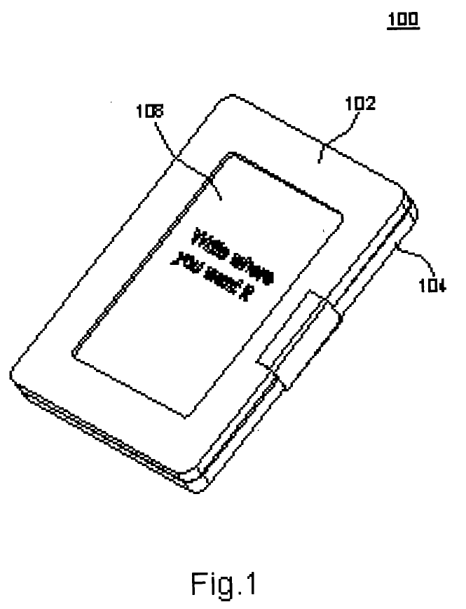

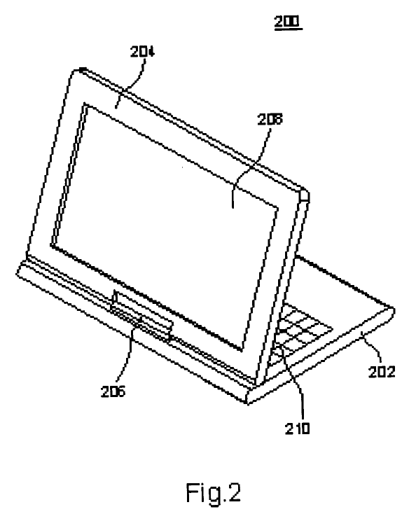

FIG. 9 shows a schematic diagram of the cover separated from the base in another preferred embodiment of the present invention. The embodiment here is similar to the embodiment in FIG. 1, and is not elaborated here. The connection element 906 can be used to assemble the base 902 and the cover 904. In other words, a portable computer 900 can be used like the embodiment in FIG. 1. Besides, the portable computer 900 can be disassembled into the base 902 and the cover 904 by taking apart the connection element 906. Information can be transmitted via wireless transmission like infrared rays transmission between the base 902 and the cover 904. Through wireless transmission, users can also input data from a remote system.

It has to be clarified that although mentioned embodiments use bi-axis connection elements, it is not limited to the embodiments here and every design making the cover rotate 360 degrees to the base is included. The one skilled in the art can modify the embodiment to fit his need.

To sum up, the present invention provides a portable computer with a flat panel display. Users can input data by an input device or through the flat panel display. The difference between the present invention and prior art is the display assembled in the base and the input device assembled in the cover which make the design of electrical connection easier, reduce the cost of manufacture and maintenance, and raise the reliability of the products.

While the invention has been described in connection with what is presently considered to be the most practical and preferred embodiments, it is to be understood that the invention is not to be limited to the discovered embodiments. The invention is intended to cover various modifications and equivalent arrangement included within the spirit and scope of the appended claims.

1. A portable computer with a flat panel display, comprising:
a base including a computer system and the flat panel display; and
a cover, having a connection element pivotally connected to the base for protecting the base, the cover including an input device to input data;
wherein the cover axially rotates around the connection element and protects the base.

2. The portable computer according to claim 1, wherein as the cover is in a first position, the cover shelters a first portion of the base.

3. The portable computer according to claim 2, wherein as the cover rotates 360 degrees from the first position to a second position, the cover shelters a second portion of the base to protect the flat panel display.

4. The portable computer according to claim 3, wherein the connection element includes a first axis and a second axis, the cover selectively rotates 180 degrees around the first axis and the second axis respectively.

5. The portable computer according to claim 1, the portable computer further comprising:
a bracket connecting to the base;
wherein as the base is disposed on a plane, the bracket supports the base making the base intersect the plane at an angle.

6. The portable computer according to claim 1, wherein the cover is removably connected to the base.

7. The portable computer according to claim 1, wherein the flat panel display is used to input data through handwriting.

8. The portable computer according to claim 1, wherein the input device includes a flat panel keyboard.

9. The portable computer according to claim 1, wherein the input device includes a conductive-rubber keyboard.
